(19) United States
(12) Patent Application Publication
(10) Pub. No.: US 2011/0000410 A1
(43) Pub. Date: Jan. 6, 2011

(54) SEEDING ASSEMBLY IN GRAIN SEEDING MACHINES

(76) Inventors: Castagno Manasseri, Canelones (UY); Reymundo Poggio, Canelones (UY)

Correspondence Address: COLLEN IP, THE HOLYOKE MANHATTAN BUILDING, 80 SOUTH HIGHLAND AVENUE, OSSINING, NY, 10562, US

(21) Appl. No.: 12/830,867

(22) Filed: Jul. 6, 2010

Related U.S. Application Data
(63) Continuation-in-part of application No. 12/340,059, filed on Dec. 19, 2008.

(30) Foreign Application Priority Data
Dec. 20, 2007 (UY) 30828

(51) Int. Cl. A01C 5/08

(52) U.S. Cl. 111/163

(57) ABSTRACT

A seeding assembly in grain seeding machines, in which the position of some of the usual devices is modified and some others are redesigned, adding on the depth control device a hinge placed on the front part of the opener disks, which allows the angular opening of the depth control wheels with respect to the furrow opening disks, minimizing the entry of vegetable residues, dust, moist, soil, etc., and providing efficient and prompt cleaning of the existing space between the wheels and the disks, with the purpose of reducing detention time of the seeding machine.

This application is a continuation in part of application Ser. No. 12/340,059 filed on Dec. 19, 2008.

### 1. BACKGROUND OF THE INVENTION

This invention describes a seeding assembly in grain seeding machines, more precisely, a seeding assembly with a hinge mechanism in the front part of the assembly, that brings closer and separates the depth control wheel from the opener disk, the main effect of which is to minimize the entrance of vegetable residues, dust and moist soil, aiding expulsion thereof, and providing an efficient and prompt cleaning to avoid longer detention time of the machine.

This innovation originates from the constant improvement searched on grain seeding machines, particularly, those used for so-called direct seeding or no-till seeding.

Moreover, Argentinean registrations of Invention patents, belonging to the firm named Avec S. R. L, such as:

No. 247466—Dispositivo óleo—neumático de control de cargas (Oil pneumatic load control device)

No. 249176—Mejoras en un dispositivo óleo—neumático de control de cargas (Improvements on an oil—pneumatic load control device)

No. 250967—Conjunto articular de brazo principal y balancin (Joint assembly of main arm and balance beam)

is the background based on which, upon constant operation development and improvement, the present innovation is produced.

Before description of the invention there is a brief description of the background.

The Oil-pneumatic Load Control Device, together with the Balance Beam System, provides exact regulation of the preset loads based on the soil to be seeded. The loads are therefore kept constant at all times, regardless of the unevenness of the soil. Therefore, a constant load combined with the perfect tracing of the soil guarantees uniformity in seeding depth followed by the appropriate covering.

The problem associated to this study is a result of the obstruction with vegetable residues, dust or moist soil, which enter between some of the components of the so called “seeding assembly” or “seeding train”.

The development of this invention is inspired on the arrangement of the known seeding assembly elements, the fact that said assemblies are rigidly conformed, and the poor adaptability for their self cleaning or evacuation of the vegetable residues, dust, etc. One object of this invention is to improve adaptability of the assembly, achieve an easy and correct evacuation of the accumulated residues and provide the user of the seeder higher effectiveness, work efficiency, and most importantly, the minimization of detention time caused by obstruction of the seeding assembly.

### 2. SUMMARY OF THE INVENTION

Generally seeding assemblies include the following:
a) A device to open the furrow, usually composed of one or two flat disks 1 (single disk, double disk), mounted with a certain inclination in relation to vertical and horizontal planes, which allows them to perform such task, or composed of a kind of spike or hoe (not shown) (see FIG. 1);
b) A device to place the seed from a storage hopper (not shown) to the bottom of the furrow, generally consisting of a flexible tube (not shown) connected to a rigid tube 2 placed between both disks or on the side of the single disk;
c) A device to place fertilizer from a storage hopper (not shown) to the bottom of the furrow, generally consisting of a flexible tube (not shown) connected to a rigid tube 3 placed between both disks or at the side of the single disk (this is what commonly occurs when fertilization and seeding take place simultaneously).
d) A device to control depth of the seed in the furrow; this may be carried out by rings laterally attached to one of the furrow disks (or to the single disk) (not shown), or either by one or two wheels with rubber tires 4 indicated on FIG. 1; in the case of rings, the different depths are regulated by varying the size (diameter) of the rings; whereas in the case of wheel(s) there is a specifically designed mechanism 5 for said regulation of depth, for example the one indicated on FIG. 1;
e) A device to close the furrow, which usually consists of one or two wheels with rubber tires 6; to which serrated disks are normally attached;
f) There are some designs which also include a device which presses the seed against the furrow walls, after said seed has been placed therein and before closing the furrow; generally said device is a metal wheel 7 or it includes a rubber or plastic tire.

The above mentioned elements from a) to f) are well known in the previous art and can have different designs, therefore any constructive details about them will be given. They are usually placed on a socalled balance beam 8 on the present invention and on the above mentioned Argentinean patents, generally a straight one, ordered in such a way that they operate with the correspondent sequence (furrow opening up to certain depth; placing of the seed and fertilizer; seed pressing; furrow closing).

The present invention describes a new arrangement of the elements available in “seeding assembly or seeding train”, understood as the set of structural elements and mechanisms needed to perform seeding work on a single furrow, therefore it is necessary on a typical grain seeder, to have several seeding assemblies placed next to each other, in one or more toolbars, to cover the seeding width and the distance between furrows needed. Said new arrangement not only improves and provides better efficiency to the work on general terms, it also perfects the depth control system, provides adaptability to the assembly, and moreover, innovates the mechanism, providing regulation and articulation which improves self cleaning of its elements; by both minimizing the amount of residues entering the assembly and providing to said residues an easy way out of it.

In summary, the assembly herein introduced, achieves, by means of its new arrangement and modification of the elements, a more efficient operation, improvement of the depth control system and simplification of the cleaning of the assembly through the new arrangement of its regulation and articulation of the mechanism.

### 3. BRIEF DESCRIPTION OF DRAWINGS

The advantages of this invention will be apparent upon consideration of the following detailed disclosure of the invention, especially when considered with the accompanying drawings wherein:

FIG. 1: Side view of the seeding assembly.

FIG. 2: Top view of three adjacent seeding assemblies.

FIG. 3: Detailed top view of depth control wheels and disks on the closed position of hinges.

FIG. 4: Detailed top view of hinges on closed and open positions.

### 4. DETAILED DESCRIPTION OF THE INVENTION

The innovation presented herein develops from the complications registered, which have been observed, and which are associated to the practical use of the grain seeders in general.

However, particularly we refer to the seeder which applies the oil-pneumatic device patented under number 247466, which produced the first modification or improvement in patent under number 249176 “Improvements on an oil pneumatic load control device . . . ” which was finally modified in patent under number 250967 “Joint assembly of main arm and balance beam, applied to agricultural machines”.

In said invention patent (250967) the elements of the joint assembly are described, featuring a main arm, on one end articulated to the machine frame, on the other end articulated to a bracket projected underneath thereof, inside which there is an area crossed by the balance beam, the latter articulated to spin in a transversal shaft which is provided in the bottom end of said bracket; the balance beam is joint to the furrow opener disks through a connecting piece fixed to one end of the balance beam, whereas the covering wheel which is part of the arrangement, is fixed—by means of sliding mounted clamps—in adjustable position on the side of the balance beam opposite to the referred articulated bracket.

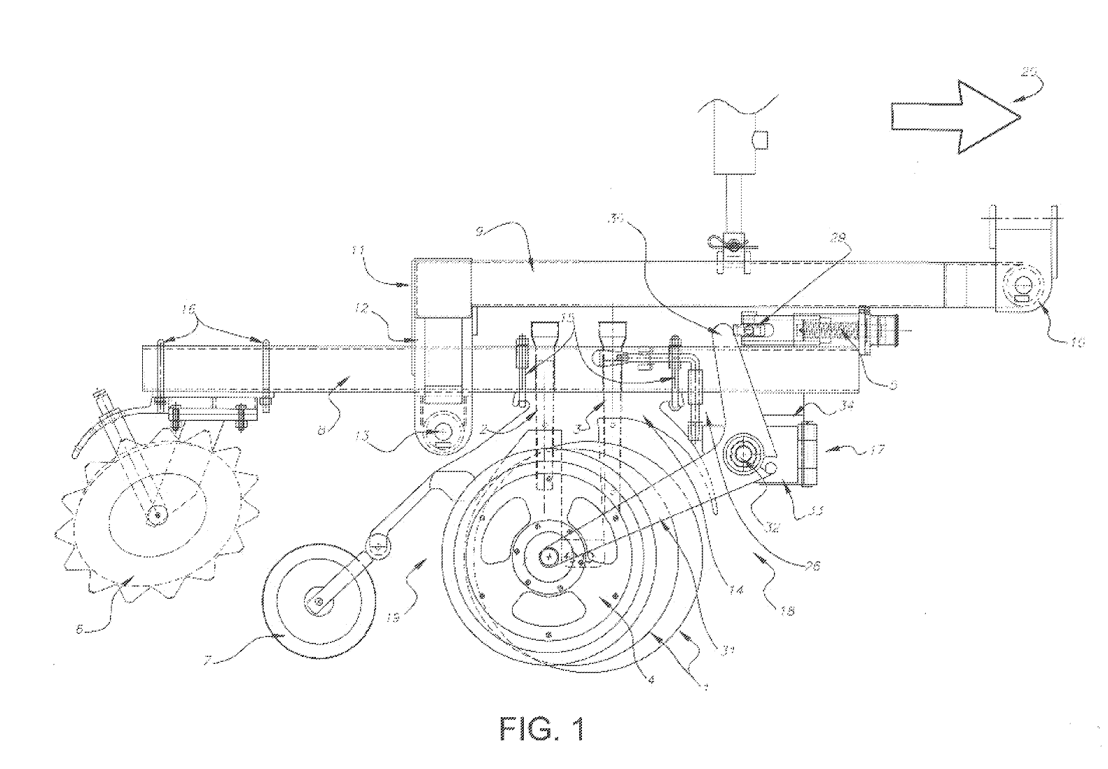

The new joint assembly proposed features the arrangement of the elements involved on the seeding assembly as shown on FIG. 1, characterized by a main arm 9, on one end 10 articulated to the machine frame (partially shown) which allows it to move upwards and downwards, having on the other end 11 a bracket 12 projected underneath thereof, inside which there is an area crossed by the balance beam 8, the latter articulated to spin in a transversal shaft 13 which is provided in the bottom end of said base; the balance beam 8 is joint through a connecting piece 14 fixed to one sector of the balance beam 8 by means of “U” shaped clamps 15, to the furrow opener disks 1, the depth control wheels 4 and the seed press wheel 7, whereas on the sector of the balance beam 8 located on the opposite side of said articulation bracket 12, the covering wheel 6 is fixed, by means of sliding mounted “U” shaped clamps 16, in adjustable position on said balance beam 8. The main arm is 9 is actuated upwards or downwards with a certain and preset force depending on seeding conditions, by means of a hydraulic cylinder (only partially shown) which is part of the oil pneumatic load control device mentioned above.

One of the objects of the present invention is the new design of the depth control system, which improves its functionality. Moreover, the new arrangement and modification of the present invention minimizes the entrance of elements, such as vegetable residues, dust, moist soil, etc., into the existing space between the wheel and the disk, in turn improving evacuation of the few elements that enter the assembly.

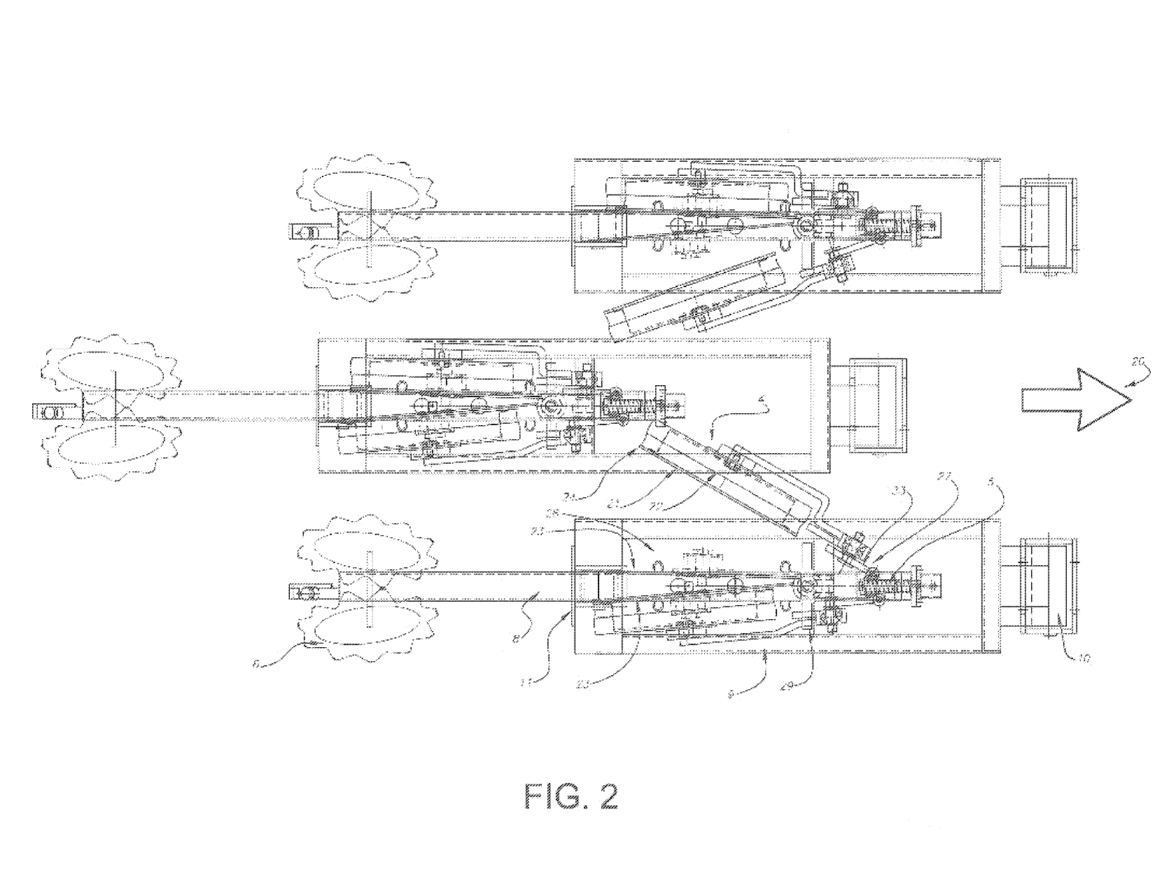

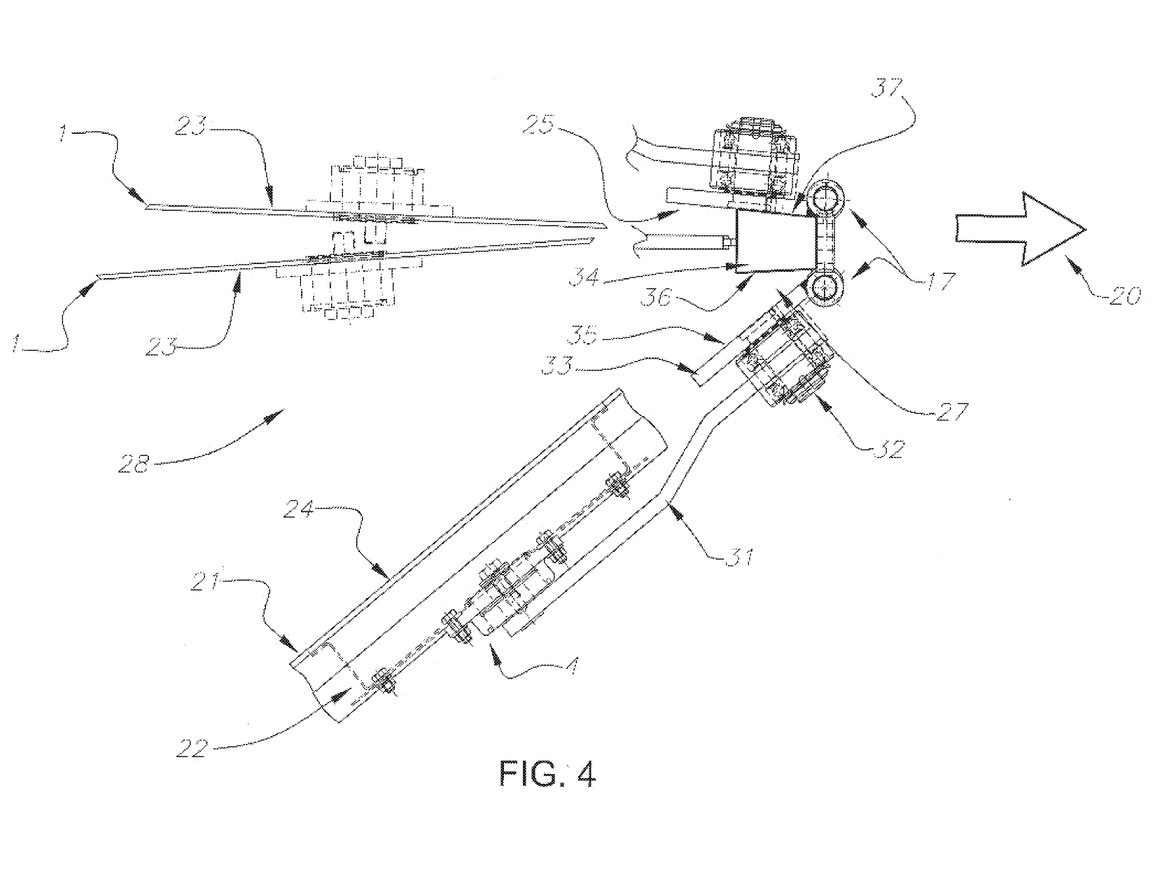

A further improvement applied to the invention is the conformation of a hinge mechanism or hinged articulation 17 as the one shown on FIG. 1, FIG. 2 and FIG. 4, which provides, firstly, regulation of the seeding depth and, secondly, articulation of the elements of the mechanism, achieving minimized detention times of the machine for cleaning the seeding assemblies.

### DESCRIPTION OF THE PREFERRED EMBODIMENT

For the purpose of enlightening the invention, which is defined as “Seeding assembly in Grain Seeding machines”, for its simple application, its preferred embodiment shall be described with precision in the following paragraphs, making reference to the attached descriptive drawings. The purpose is to describe the invention without limiting it, and the components may be selected from different equivalents, without deviating from the invention principles defined in the present document. The invention is described based on the above mentioned Argentinean patent No. 250967, “Joint assembly of main arm and balance beam . . . ”, where almost all the set of mechanisms are already known, but with the new arrangement as shown on FIG. 1 and FIG. 2, where some of the elements of the seeding assembly or seeding train have been redesigned and/or redistributed.

In the already known arrangements, the depth control wheels may be located in the front or rear of the furrow opener disks (considering the running direction of the seeder and thus of the seeding assemblies).

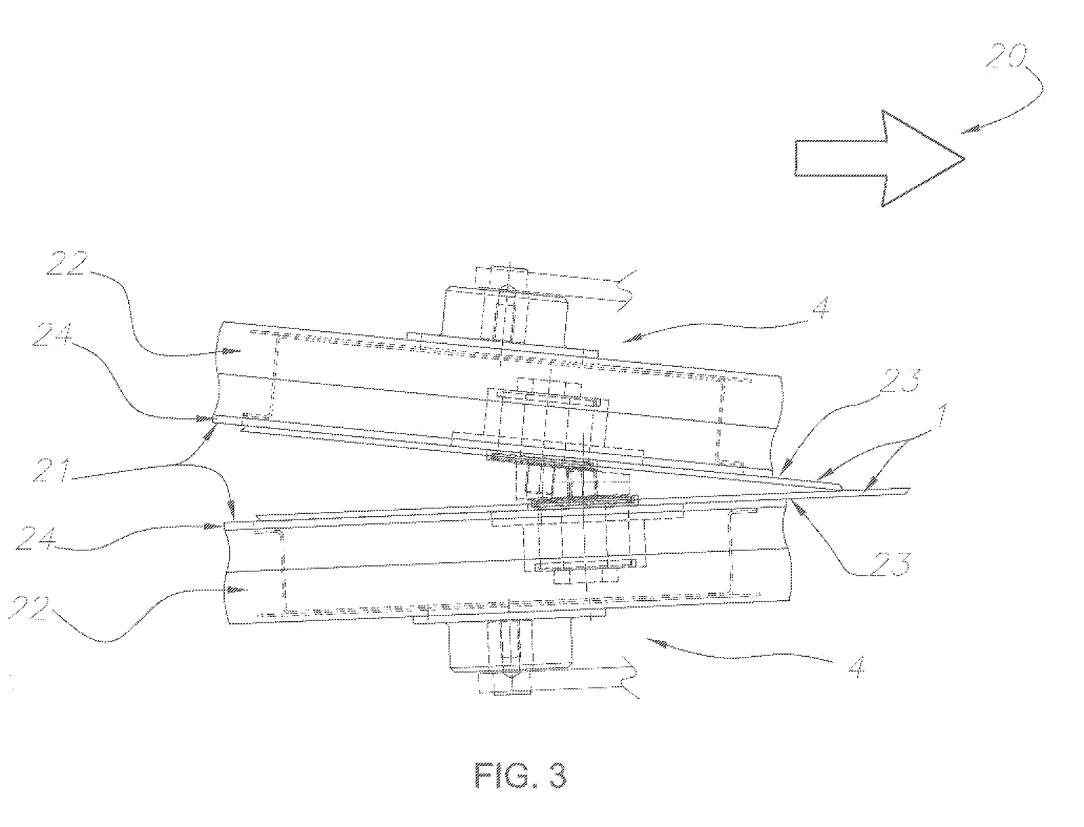

In the preferred embodiment, shown as a set on FIG. 1 and FIG. 2, the arms 31 that rotationally support the depth control wheels 4 are attached to the front part 18 of the furrow opener disks 1 by means of the hinges 17. To improve efficiency of the wheel's function, the internal side faces 21 of the tires 22 of the depth control wheels 4, must be as close as possible to the external side faces 23 of disks 1, as shown in detail on FIG. 3. In the, present design, the tire 22 of the depth control wheel 4 includes a kind of “lip” 24 in the internal side face 21 positioned adjacent to the external side face 23 of disk 1, to achieve a minimum distance between the external side face 23 of the disk 1 and the internal side face 21 of the tire 22 of the depth control wheel 4. This minimum distance between these two faces should be permanent, whatever the position of the depth control wheel 4 with respect to the disk 1 (higher or lower position, depending on the necessary seeding depth), also considering the dynamic of the seeding operation in general terms and of the no-till seeding in particular, which, since it is carried out on vegetable residues or coverings, causes the same to be introduced into the space between the wheel and the disk, usually together with dust and moist soil. This causes several problems, the most important of them being the reduction of the operative performance of the machine, due to the frequent detention of the operation for cleaning seeding assemblies, which in some cases even hinders proper seeding.

These operation problems have originated the necessity to redistribute elements and to improve the previous seeding assemblies designs, taking into account these difficulties perceived during field work.

The present invention is a set of mechanisms, based mostly on Invention Patent No. 250967 “Joint assembly of main arm and balance beam . . . ”, in which the new arrangement of the elements provides a simple cleaning of the space between the depth control wheels 4 and the disk 1, minimizing the detention time of the machine, which is achieved by means of the hinged articulation (or simply “hinge”) 17 shown on FIG. 1, FIG. 2 and FIG. 4. The location of the hinge 17 at the front part 18 of the disks 1, makes that the dynamic of the forces involved in the seeding task tends to bring closer the internal side face 21 of the rubber tire 22 of the depth control wheel 4 to the external side face 23 of disk 1 (see FIG. 2 and FIG. 3), and thus achieving that separation between the two faces is minimal (for example, in regular working conditions, no greater than 0.012/0.020 inches or 0.3/0.5 mm); this situation is unaltered whatever the position of the depth control wheel 4 with respect to the disk 1 (upper or lower position depending on the seeding depth needed) is, since the movement is always parallel to the external face 23 of the disk 1. On the contrary, with the location of the hinge 17 to the rear part 19 of the disks 1, the depth control wheel 4 tends to separate from disk 1, and this makes the entrance of the unwanted elements easier. However, location of the attachment of the depth control wheels to the front part of disks is not an innovation, since some seeders already include it.

The innovation herein basically consists of a hinge 17, which in closed position 25 indicated on FIG. 2 and FIG. 4, makes internal side face 21 of the rubber tire 22 of the depth control wheel 4 to be positioned adjacent to external side face 23 of the furrow opener disk 1 and thus, such position remains perfectly fixed through a lock 26, for example of the design indicated on FIG. 1, and in open position 27, shown on FIG. 2 and FIG. 4, allows the depth control wheel 4 to be separated from the disk 1 and therefore the extended space 28 between them can be easily cleaned as shown on FIG. 2 and FIG. 4.

As shown on FIG. 1 and FIG. 2, depth regulation is carried out by operating, for example, a mechanism with a square—threaded screw 5, which design is well known in the previous art, with an articulated end 29 which (see FIG. 1) actuates on the levers 30 attached to the arms 31 of the corresponding depth control wheels 4. Said articulated end 29 of the depth control mechanism, provides free and separate movement of both depth control wheels 4 of the system. The arms 31 of depth control wheels 4 spin in the shaft 32 fixed to the mobile plate 33 of the hinge 17.

We shall describe the invention based on Invention Patent No. 250967, “Joint assembly of main arm and balance beam . . . ”, where the whole set of mechanisms is almost completely known, but including the new arrangement, as shown in FIG. 1, in which some of the elements of the seeding assembly or seeding train have been redesigned and/or redistributed.

Moreover, one of the novelties of the present invention consists of the hinge 17 of FIG. 1, FIG. 2 and FIG. 4, which on its mobile plate 33 have the set of elements that allows the internal side face 21 of the tire 22 of the depth control wheel 4 to be positioned at a minimum distance of the external side face 23 of the furrow opener disk 1 and this position remains perfectly fixed by a lock, for example of the design indicated with 26 on FIG. 1. In the current design the fixed plate 34 of the hinge 17 is a part of the connecting piece 14. The internal side face 35 of the mobile plate 33 and the internal side face 36 of the fixed plate 34 of the hinge 17 are flat, and in closed position 25 are parallel to each other, making contact throughout the area 37 they have in common, and are in turn parallel to the external side face 23 of the corresponding disks 1. The shaft 32 is fixed to the mobile plate 33 of the hinge 17 perpendicularly to the internal side face 35 thereof.

On the other hand, the hinge 17, in open position 27, brings the depth control device the necessary extended space 28 between the depth control wheel 4 and the furrow opener disk 1, for a proper and prompt cleaning.

The use and practice of the seeding machinery which showed the inconveniences of the obstruction with residues encouraged to place and use the hinge articulation 17, and the new arrangement of the fixing assembly of depth control wheels 4, which being on its preferred embodiment located at the front part 18 of the furrow opener disks 1 takes advantage of the components of the acting forces over the different elements during seeding tasks, helping to maintain the minimum distance between the internal side face 21 of the tire 22 of the depth control wheel 4 and the external side face 23 of disk 1.

Thus, one of the manufacturing options has been reviewed, and therefore the invention and its application have been defined, and without this implying a limitation, the invention is in line with the specification, claims and attached drawings, which further complement the description of the invention.

1. Seeding assembly in seeding machines including:
a. A device for furrow opening
b. A device for directing the seed into the furrow
c. A device for directing the fertilizer into the furrow
d. A device to control the depth of seeding
e. A device for furrow closing
f. A device to press the seed
Characterized by having on the front part of the assembly the articulation of the arms of a seeding depth control device with a mechanism, for example a hinge, which allows the angular movement of approach and separation of the depth control wheel with respect to the corresponding furrow opening disk.

2. Seeding assembly in seeding machines, according to claim 10, in which the hinge, on its closed position, allows the internal side face of the tire of the depth control wheel to be positioned at a minimum separation of the external side face of the corresponding furrow opening disk, maintaining such separation whatever the position of the wheel respect to the disk on its upwards or downwards movement is.

3. Seeding assembly, according to claim 10, characterized by the fact that the depth control wheel moves upwards and downwards on a plane parallel to the external side face of the corresponding furrow opener disk.

4. Seeding assembly, according to claim 10, characterized by the fact that the internal side faces of the mobile and fixed plates of the hinge are flat and, in closed position, parallel to each other, and these, in turn, are parallel to the external side face of the corresponding furrow opener disk.

5. Seeding assembly, according to claim 10, characterized by the fact that the shaft where the depth control wheel arm pivots is perpendicular to the internal flat side face of the mobile plate of the hinge.

6. The hinge of claim 11 characterized by the fact that on its closed position, the internal side face of the tire of the depth control wheel is positioned adjacent to the external side face of the corresponding furrow opener disk, at a minimum separation, and it is fixed by a lock, for example of the design indicated on FIG. 1, and on its open position, separates the depth control wheel of the corresponding furrow opener disk.

7. Seeding assembly, according to claim 10, in which regulation of the seeding depth is done operating, for example, a square—threaded screw which articulated end operates on the levers attached to the arms of the corresponding depth control wheels.

8. The lock, according to claim 15, characterized by the fact that when operated manually releases the mobile plate of the hinge, in such a way that the depth control wheel attached to it pivots with increasing angle with respect to the furrow opening disk to enlarge the space between them, and with decreasing angle to place it close to the furrow opening disk, up to a final location in which it once again locks manually.
